(19) United States
(12) Patent Application Publication
(10) Pub. No.: US 2026/0322135 A1
(43) Pub. Date: Oct. 15, 2026

(54) MICROGRID CONTROL SYSTEM AND A METHOD OF CONTROLLING A MICROGRID

(71) Applicant: Swanbarton Limited, Malmesbury (GB)

(72) Inventors: Anthony Price, Pinkney (GB); David Mutch, Pinkney (GB); Hamish Campbell, Pinkney (GB); James Jinks, Pinkney (GB); Christopher Price, Pinkney (GB)

(21) Appl. No.: 19/693,193

(22) Filed: May 29, 2026

Related U.S. Application Data
(63) Continuation of application No. PCT/GB2024/052930, filed on Nov. 20, 2024.

(30) Foreign Application Priority Data
Nov. 29, 2023 (GB) 2318234.8

(51) Int. Cl. H02J 3/466; H02J 3/14; H02J 3/388

(52) U.S. Cl. CPC H02J 3/466; H02J 3/14; H02J 3/388

(57) ABSTRACT

Microgrids are local electrical grids that act as single controllable entities, and typically contain power supply units and load units 101-110. Centralized control of a microgrid involves a large amount of information being transmitted to a central controller before a decision can be made regarding which power units to activate or deactivate, and then instructions need to be sent back to implement the decision. The present invention provides a plurality of negotiation units configured to operate respective power units 101-110 in response to collating from each other negotiation unit respective power outputs/demands and priority identifiers, and using a common method to determine which power units to operate. In this way, instructions do not need to be sent back to individual local nodes from the control node.

### RELATED APPLICATIONS

This application claims the benefit under 35 U.S.C. § 120, and is a continuation, of co-pending International Application PCT/GB2024/052930, filed Nov. 20, 2024 and designating the US, which claims priority to GB Application 2318234.8, filed Nov. 29, 2023, such GB Applications also being claimed priority to under 35 U.S.C. § 119. These GB and International applications are incorporated by reference herein in their entireties.

### FIELD

The present invention relates generally to a microgrid control system and a method of controlling a microgrid and finds particular, although not exclusive, utility in island microgrids.

### BACKGROUND

Microgrids are local electrical grids that act as single controllable entities, and may operate in grid-connected and/or island modes. Grid-connected microgrids normally operate in synchronization with a traditional wide-area grid (macrogrid). In island mode, a microgrid may be stand-alone. In particular, some microgrids are not intended to be connected to a macrogrid, and would therefore be incapable of being connected effectively/safely, and are known as island microgrids.

Microgrids typically contain a plurality of power supply units and a plurality of load units, and optionally may contain one or more energy storage units (which therefore may operate as either a power supply unit or a load unit, depending on the level of storage). Such power units often interconnect so as to have clearly defined electrical boundaries that enable the microgrid to act as a single controllable entity.

Microgrids are typically low voltage or medium voltage (up to 35 kV) distribution systems that include distributed energy resources (DERs) (e.g. microturbines, fuel cells, photovoltaics (PV), etc.), energy storage devices (batteries, flywheels, etc.) and/or loads.

### SUMMARY

Centralized control of a microgrid involves a large amount of information being transmitted to a central controller before a decision can be made regarding which power units to activate or deactivate, and then instructions need to be sent back to implement the decision. Centralized control is inflexible, requiring one node to be dedicated to control, and operation of the microgrid to be dependent entirely on that node's successful operation.

In contrast, decentralized control involves local controllers that decide on activation or deactivation of their own respective power units in the absence of knowledge about other power units in the microgrid. For example, some local controllers may monitor the power frequency and respond accordingly, or may predict future network use based on trends or predictions. This can result in large discrepancies between power supply and demand.

The present invention seeks to overcome these disadvantages.

According to a first aspect of the present invention, there is provided a microgrid control system, for use with a microgrid of the kind comprising: a plurality of power units connected together, the plurality of power units comprising: at least one power supply unit; and at least one load unit; the microgrid control system comprising: a plurality of negotiation units, each one of the negotiation units configured to: communicate with each one of the other negotiation units of the plurality of negotiation units; and operate a respective power unit in response to said communication; the system configured to conduct negotiation between the negotiation units, the negotiation comprising: each negotiation unit sending to each other negotiation unit information comprising: a unique identifier; a power output/demand of its respective power unit; and a priority identifier of its respective power unit; in response to receiving the information, each negotiation unit using a common method to determine which power units to operate; and in response to determining which power units to operate, each negotiation unit activating or deactivating its respective power unit in accordance with said determining; wherein the common method comprises: determining a current total power demand of the microgrid; determining a current total power available to the microgrid; determining a current power excess, equal to the current total power available to the grid less the current total power demand of the grid; grouping the power supply units in ascending order of priority identifier to obtain an ordered list of power supply priority; deactivating where necessary, in order of the ordered list of power supply priority, as many of the power supply units as possible without exceeding the current power excess; activating where necessary the remaining power supply units; determining a current power ceiling, equal to the current total power available to the grid; grouping the load units in descending order of priority identifier to obtain an ordered list of load priority; activating where necessary, in order of the ordered list of load priority, as many of the load units as possible without exceeding the current power ceiling; and deactivating where necessary the remaining load units.

In this way, and in contrast to centralized control, instructions do not need to be sent back to individual local nodes from the control node, thereby saving time. In addition, failure of one negotiation unit merely results in removal of the respective power unit from the microgrid; in contrast, failure of the control node of a centralized system would result in failure of the entire microgrid. Similarly, a break in the system (intentionally or unintentionally), severing a cluster of local nodes from the control node would result in the associated power units not being able to operate; whereas in contrast, a break that severs a first cluster of negotiation units from a second cluster of negotiation units merely results in two independently operating microgrids. Compared to decentralized control, the present invention allows much more effective control of assets.

Each power unit may comprise a power supply unit and/or a load unit. For example, a power supply unit may comprise an item of renewable energy generation equipment, such as a wind turbine and/or solar PV cell, a conventional generator, such as a diesel generator, and/or some other form of power supply unit. A load unit may comprise distribution board, consumer unit, or other electrical gateway beyond which individual loads may be used. Alternatively or additionally, a load unit may comprise a single individual load such as a heating system, computer system, cooking equipment, etc.

The power unit may be a power storage unit, which may function as either a power supply unit (when discharging) or a load unit (when charging), for example a battery of an electric vehicle or a hydroelectric system.

The plurality of power units may be connected together into a microgrid.

The system may comprise only two negotiation units, or may comprise an arbitrary number of negotiation units, for example at least five, at least ten, at least twenty, at least fifty, etc.

Each negotiation unit may be configured to operate only one respective power unit or more than one respective power unit; that is, at least one respective power unit.

Each negotiation unit may comprise a computer system, which may be stand-alone, and may comprise a processor, transceiver and/or local memory.

Communication between the negotiation units may comprise all-to-all communication, broadcasting and/or multicasting addressing methods.

Communication between the negotiation units may comprise/be via power line communication. In this way the presence of communication between two negotiation units ensures the presence of the power units in the microgrid. However, other forms of wired and/or wireless communication could be used in principle. For example, communication between the negotiation units may comprise ethernet, Wi-Fi®, Bluetooth® and/or a telecommunication network.

Operating a respective power unit in response to said communication means operating the respective power unit subsequent to the negotiation.

Negotiation may be carried out in phases. Each phase of negotiation may conclude after a predefined timespan, of at most 5 s, in particular at most 2 s, more particularly at most is, for example after 0.5 s, 1 s, 2 s or 5 s.

Each phase of negotiation may occur after a predefined time interval, of at most 5 s, in particular at most 2 s, more particularly at most is, for example after 0.5 s, 1 s, 2 s or 5 s. The predefined time interval may be calculated from the start or end of the preceding negotiation phase.

In this way, negotiation may be carried out effectively in real time.

The unique identifier may be an IP address, MAC address, IMSI number, and/or any other unique identifier.

The power output/demand of a power unit may comprise the current power output/demand and/or a rated power output/demand. The current power output/demand may be lower than the rated power output/demand, the latter being an upper design or practical limit on the possible current output/demand.

The power output may comprise the power supplied by a power supply unit. The power demand may be the power required by a load unit.

The priority identifier of a power unit may be a one-dimensional number indicating the power unit's position in a hierarchy. The priority identifier may be a number, for instance a rational number between zero and one, a natural/rational number between one and ten, or zero and one hundred, or any other suitable range.

The negotiation unit information may further comprise an indication of time for which its respective power unit has been active.

Alternatively, each negotiation unit may keep a record of recently active power units, and may therefore not need to be informed of the activity of each power unit each negotiation phase.

Each negotiation unit using a common method to determine which power units to operate may involve each negotiation unit duplicating the processing of each other negotiation unit and optionally acting accordingly.

In this way, each negotiation unit may control its respective power unit without needing to wait for further communication.

In alternative arrangements, the result from a (or each) negotiation unit may be compared with the result from at least one other negotiation unit. In case of discrepancy, the negotiation units may take no controlling action, may seek further comparison from a further negotiation unit, and/or may defer to a negotiation unit of a higher priority. In this way, the system could default to a centralized system, in the event of catastrophic discrepancies.

A negotiation unit controlling a power unit comprises activating or deactivating. In this context, activating may mean turning on, and deactivating may mean turning off, for example by using a switch and/or relay. If a negotiation unit determines it is to operate its respective power unit, and said power unit is switched off, it would activate said power unit. If a negotiation unit determines it is to operate its respective power unit, and said power unit is already switched on, it would take no action. If a negotiation unit determines it is not to operate its respective power unit, and said power unit is already switched off, it would take no action. If a negotiation unit determines it is not to operate its respective power unit, and said power unit is switched on, it would deactivate said power unit.

The common method may comprise a method that each negotiation unit carries out.

The or each negotiation unit may be provided with IT security boards/cards to provide cyber security.

The or each negotiation unit may be a distinct unit separate from and connectable to its respective power unit. Alternatively, the or each power unit may comprise a respective negotiation unit as part thereof.

Determining the current total power demand of the microgrid may comprise summing the current power demand for (previously) activated load units and rated power demand for deactivated load units.

In this way, a more accurate value may be achieved. However, in alternative arrangements, only rated power demand may be considered.

Determining the current total power available to the microgrid may comprise summing the rated power output of all available power output units. That is, summing all the rated power outputs provided by the plurality of negotiation units. In this way, a maximum value may be achieved.

Grouping the power supply units in ascending order of priority identifier may comprise creating a single ordered list in which no two list elements share the same priority, from lowest priority to highest priority (irrespective of the actual numerical value of the priority identifier).

Grouping the power supply units in ascending order of priority identifier may comprise allocating each power supply unit to a bin; that is, an interval.

In this way, a single bin may contain multiple power supply units having the same priority identifier.

The common method may further comprise, for each group of power supply units (i.e. bin), arranging the power supply units within that respective group in ascending order of time for which the respective power supply unit has been active, to obtain the ordered list of power supply priority.

In this way, power supply units that have been activated for longer are assigned a higher priority in the ordered list than other power supply units of an identical priority identifier.

In this way, deactivating where necessary, in order of the ordered list of power supply priority, as many of the power supply units as possible without exceeding the current power excess may be considered a last-in first-out process.

Nevertheless, it is to be appreciated that other arrangements of the power supply units within respective groups is possible, including in descending order or at random.

Deactivating where necessary, in order of the ordered list of power supply priority, as many of the power supply units as possible without exceeding the current power excess may comprise deactivating where necessary, in order of the ordered list of power supply priority, as many of the power supply units as possible without exceeding the current power excess, unless a specific power supply unit was activated within a hysteresis time period.

That is, deactivating where necessary, in order of the ordered list of power supply priority, as many of the power supply units as possible without exceeding the current power excess only where those power supply units have not been activated within a hysteresis time period.

In this way, if a power supply unit was activated (i.e. turned on, but not merely active) within the hysteresis time period, it will not be deactivated. In particular, another power supply unit may be deactivated instead.

The hysteresis time period may be between 5 s and 60 s, in particular between 10 s and 40 s, more particularly approximately 30 s. The hysteresis time period may be common for all negotiation units/power units.

However, in some embodiments the hysteresis time period could be chosen for each power unit, for example to cater for the response time of each power unit. In particular, slower response power units may have a longer hysteresis time, whereas faster response power units may have a shorter hysteresis time, when compared to one another. Accordingly, in such arrangements, the negotiation unit information may comprise a respective hysteresis time.

In further alternative arrangements, a hysteresis time could be determined dynamically, for example by performing frequency analysis of varying load power.

Activating where necessary the remaining power supply units may comprise activating where necessary the remaining power supply units, unless a specific power supply unit was activated within a hysteresis time period.

The common method may further comprise, if the current power excess is less than zero, reducing the current power ceiling by a headroom amount. In this way, a buffer can be created so that a power supply unit is not required to operate at its theoretical maximum unless absolutely necessary.

The headroom amount may be a predefined amount (e.g. absolute amount, or absolute amount per power supply unit), a predefined proportion of the current total power available, and/or could be calculated based on respective headroom amounts for each power supply unit. However, preferably, the headroom amount can be set centrally, with that value being propagated out to each negotiation unit.

Grouping the load units in descending order of priority identifier may comprise creating a single ordered list in which no two list elements share the same priority, from lowest priority to highest priority (irrespective of the actual numerical value of the priority identifier).

Grouping the load units in descending order of priority identifier may comprise allocating each load unit to a bin; that is, an interval.

In this way, a single bin may contain multiple load units having the same priority identifier.

The common method may further comprise, for each group of load units (i.e. bin), arranging the load units within that respective group in descending order of time for which the respective load unit has been active, to obtain the ordered list of load priority.

In this way, load units that have been activated for longer are assigned a higher priority in the ordered list than other load units of an identical priority identifier.

In this way, activating where necessary, in order of the ordered list of load priority, as many of the load units as possible without exceeding the current power ceiling may be considered a last-in first-out process.

Nevertheless, it is to be appreciated that other arrangements of the load units within respective groups is possible, including in ascending order or at random.

Activating where necessary, in order of the ordered list of load priority, as many of the load units as possible without exceeding the current power ceiling may comprise activating where necessary, in order of the ordered list of load priority, as many of the load units as possible without exceeding the current power ceiling, unless a specific load unit was deactivated within a load hysteresis time period.

The load hysteresis time period may be the same as the hysteresis time period mentioned above, or at least may be determined/defined in an analogous manner.

Deactivating where necessary the remaining load units may comprise deactivating where necessary the remaining load units, unless a specific load unit was activated within a load hysteresis time period.

The common method may comprise using a backtracking and/or dynamic programming algorithm.

In the event that insufficient power is available from the power supply units to meet the demand of the load units, the load units may be arranged in order or priority and as many of the arranged load units may be deactivated as required, such that the power output of the power supply units is not exceeded; if a specific load unit was deactivated within a hysteresis time period, that one may be skipped.

Similarly, in the event that excess power is available from the power supply units to meet the demand of the load units, the power supply units may be arranged in order or priority and as many of the arranged power supply units may be deactivated as required, such that the power demand of the load units is not exceeded by an unnecessary amount; if a specific power supply unit was activated within a hysteresis time period, that one may be skipped.

The system may further comprise a microgrid comprising: a plurality of power units connected together, the plurality of power units comprising: at least one power supply unit; and at least one load unit.

The microgrid may be an island microgrid and/or an islandable microgrid.

According to a second aspect of the present invention, there is provided a method of operating the microgrid control system of any preceding claim, the method comprising the steps of the common method described hereinabove.

According to a third aspect of the present invention, there is provided a non-transitory computer-readable medium storing instructions for carrying out the method of the second aspect.

The method of the second aspect may be carried out by the processor mentioned in the first aspect.

### BRIEF DESCRIPTION OF THE ACCOMPANYING DRAWINGS

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

FIG. 1 is a schematic of a microgrid in which a microgrid control system is operating.

FIG. 2 is a flow chart of a method of controlling a microgrid.

### DETAILED DESCRIPTION

The present invention will be described with respect to certain drawings but the invention is not limited thereto but only by the claims. The drawings described are only schematic and are non-limiting. Each drawing may not include all of the features of the invention and therefore should not necessarily be considered to be an embodiment of the invention. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequence, either temporally, spatially, in ranking or in any other manner. It is to be understood that the terms so used are interchangeable under appropriate circumstances and that operation is capable in other sequences than described or illustrated herein. Likewise, method steps described or claimed in a particular sequence may be understood to operate in a different sequence.

Moreover, the terms top, bottom, over, under and the like in the description and the claims are used for descriptive purposes and not necessarily for describing relative positions. It is to be understood that the terms so used are interchangeable under appropriate circumstances and that operation is capable in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other. For instance, wireless connectivity is contemplated.

Reference throughout this specification to “an embodiment” or “an aspect” means that a particular feature, structure or characteristic described in connection with the embodiment or aspect is included in at least one embodiment or aspect of the present invention. Thus, appearances of the phrases “in one embodiment”, “in an embodiment”, or “in an aspect” in various places throughout this specification are not necessarily all referring to the same embodiment or aspect, but may refer to different embodiments or aspects. Furthermore, the particular features, structures or characteristics of any one embodiment or aspect of the invention may be combined in any suitable manner with any other particular feature, structure or characteristic of another embodiment or aspect of the invention, as would be apparent to one of ordinary skill in the art from this disclosure, in one or more embodiments or aspects.

Similarly, it should be appreciated that in the description various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Moreover, the description of any individual drawing or aspect should not necessarily be considered to be an embodiment of the invention. Rather, as the following claims reflect, inventive aspects lie in fewer than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some features included in other embodiments, combinations of features of different embodiments are meant to be within the scope of the invention, and form yet further embodiments, as will be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

In the discussion of the invention, unless stated to the contrary, the disclosure of alternative values for the upper or lower limit of the permitted range of a parameter, coupled with an indication that one of said values is more highly preferred than the other, is to be construed as an implied statement that each intermediate value of said parameter, lying between the more preferred and the less preferred of said alternatives, is itself preferred to said less preferred value and also to each value lying between said less preferred value and said intermediate value.

The use of the term “at least one” may mean only one in certain circumstances. The use of the term “any” may mean “all” and/or “each” in certain circumstances.

The principles of the invention will now be described by a detailed description of at least one drawing relating to exemplary features. It is clear that other arrangements can be configured according to the knowledge of persons skilled in the art without departing from the underlying concept or technical teaching, the invention being limited only by the terms of the appended claims.

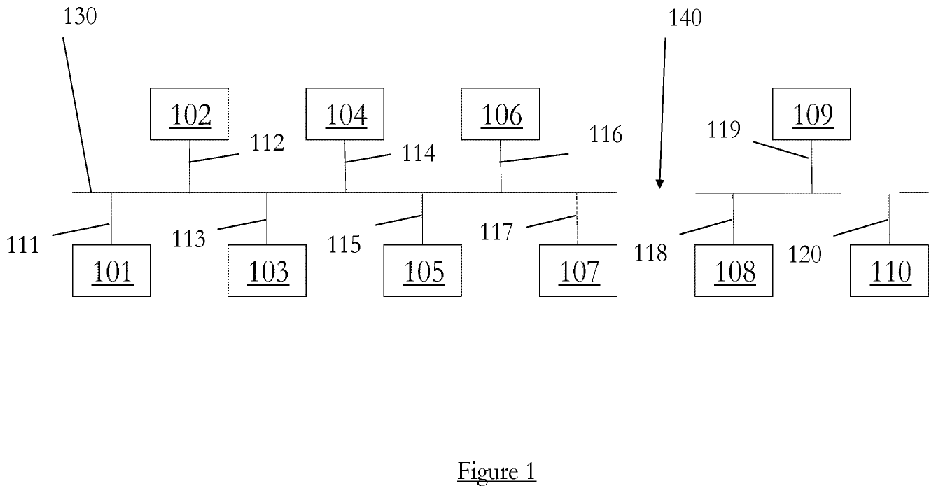

FIG. 1 is a schematic of a microgrid in which a microgrid control system is operating. The microgrid comprises ten power units 101-110 connected together via respective branches 111-120 onto a common line 130. Each of the power units 101-110 comprises a respective negotiation unit (not shown), configured to: communicate with each one of the negotiation units of the other power units 101-110; and operate (activate or deactivate) its respective power unit 101-110.

Branch 117 connecting power unit 107 to the common line 130 is indicated as a dashed, rather than solid, line in order to indicate that power unit 107 may selectively connect/disconnect from the remainder of the microgrid. Such selective connection/disconnection may or may not be intentional, as it may be governed by external factors such as power unit 107 being a remote unit (such as a vehicle). Such connection/disconnection is different/distinct from activation/deactivation of a power unit 101-110 by its respective negotiation unit. Rather, connection/disconnection is to be considered as the availability of the power unit 107 to the microgrid. Accordingly, when power unit 107 is disconnected from the microgrid, power unit 107's associated negotiation unit does not form part of any communication/negotiation with the negotiation units of other power units 101-110. When power unit 107 connects to the microgrid, negotiation by its respective negotiation unit with the negotiation units of the other power units 101-110 is possible.

Similarly, the common line 130 is shown having a dashed portion 140 between branches 117 and 118, in order to indicate a point at which the microgrid may be split into two separate (smaller or sub-) microgrids; the first sub-microgrid comprising power units 101-107 and the second sub-microgrid comprising power units 108-110.

Each sub-microgrid may behave in the same manner as the whole microgrid, for example each of the power units 101-107 of the first sub-microgrid comprises respective negotiation units configured to: communicate with each one of the negotiation units of the other power units 101-107; and operate (activate or deactivate) its respective power unit 101-107.

The above-described arrangement may be implemented in a military environment in which individual vehicles, which may operate as power supply units or load units depending on operational requirements, may link together to form small microgrids sharing resources, or may visit a permanent base where they may join a larger microgrid where their power supply capabilities are not required.

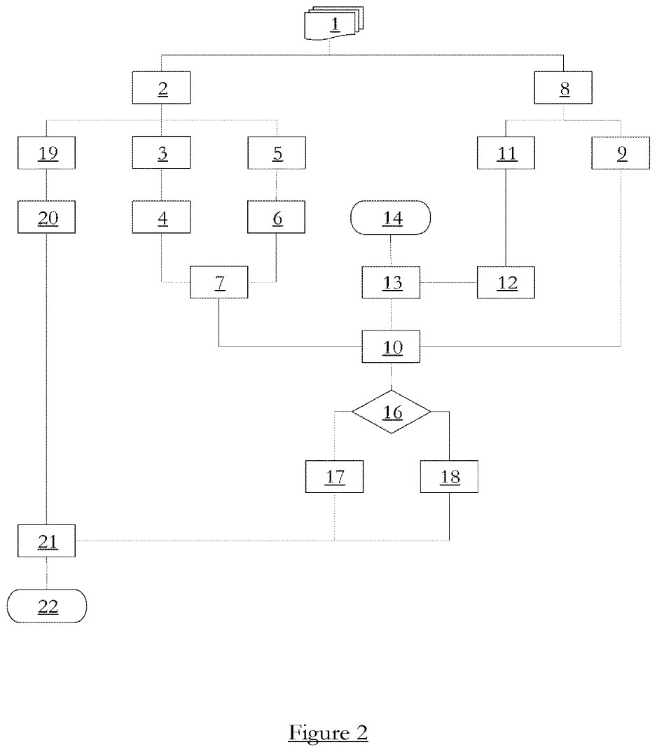

FIG. 2 is a flow chart of a method of controlling a microgrid that starts with a negotiation unit receiving 1 a communication from each of a plurality of other negotiation units in the microgrid, each communication comprising information including: a unique identifier; a respective power output/demand of an associated power unit; a priority identifier of the associated power unit; and an indication of time for which the associated power unit has been active.

In response to receiving the communications 1, the workflow splits into two paths: selecting the load units 2, and selecting the power supply units 8.

Upon selecting the load units 2, the workflow again splits into two prime routes: selecting a subset of the load units that have been previously enabled 3, and selecting a subset of the load units that have been previously disabled 5.

The measured power drawn from the previously enabled power units is then summed 4. Similarly, the rated power draw from the previously disabled power units is also summed 6. These totals are then combined to sum a total power demand of the load units 7.

Similarly, upon selecting the power supply units 8, the rated power output is summed 9 to provide total rated power output. The difference between the total rated power output and the total power demand is then determined at step 10 to establish a current power excess. The current power excess is the amount of surplus power that the microgrid is able to supply over the demand of the loads.

The power supply units selected at step 8 are grouped in ascending order of priority at step 11; that is the power supply units are ordered by their priority identifier, and any power supply units with the same identifier are grouped together with a common priority. At step 12, for each group of power supply units, the power supply units within that respective group are arranged in ascending order of time for which the respective power supply unit has been active, to obtain an ordered list of power supply priority. This assigns an effectively higher priority to those power supply units that are already active, or have been active for the longest.

In order to avoid waste by unnecessarily operating power supply units, step 13 uses the current power excess from step 10 and the ordered list of power supply priority from step 12 to deactivate (where necessary) in order of the ordered list of power supply priority, as many of the power supply units as possible without exceeding the current power excess, unless a specific power supply unit was activated within a hysteresis time period (determined from the indication of time for which the associated power unit has been active from step 1).

Then at step 14, in order to ensure that adequate power is provided to meet the demands of the load units, the remaining power supply units are activated where necessary (i.e. if not already active).

The load units selected at step 2 are grouped in descending order of priority at step 19. At step 20, for each group of load units, the load units within that respective group are arranged in descending order of time for which the respective load unit has been active, to obtain an ordered list of load priority. This assigns an effectively higher priority to those load units that are already active, or have been active for the longest.

In order to avoid overtaxing of power supply units by running them near their maximum rated output for extended periods, step 16 uses the current power excess from step 10. If the current power excess is positive, a power ceiling is set as equal to the total rated power output determined in step 9. However, if the current power excess is not positive (or is less than zero), the power ceiling is set as equal to the total rated power output determined in step 9, less a headroom amount.

In an attempt to meet as much demand as possible, subject to the foregoing, step 21 activates (where necessary) in order of the ordered list of load priority, as many of the load units as possible without exceeding the power ceiling, unless a specific load unit was deactivated within a hysteresis time period.

Then at step 22, in order to ensure enough power is provided to the higher priority load units, deactivating where necessary the remaining load units (i.e. if not already deactivated).

The process illustrated therefore starts at step 1, and bifurcates ending at steps 14 and 22. This process is executed by each negotiation unit, and is repeated after a predetermined delay repeatedly.

1. A microgrid control system, for use with a microgrid of the kind comprising:
a plurality of power units connected together, the plurality of power units comprising:
at least one power supply unit; and
at least one load unit;
the microgrid control system comprising:
a plurality of negotiation units, each one of the negotiation units configured to:
communicate with each one of the other negotiation units of the plurality of negotiation units; and
operate a respective power unit in response to said communication;
the system configured to conduct negotiation between the negotiation units, the negotiation comprising:
each negotiation unit sending to each other negotiation unit information comprising:
a unique identifier;
a power output/demand of its respective power unit; and
a priority identifier of its respective power unit;
in response to receiving the information, each negotiation unit using a common method to determine which power units to operate; and
in response to determining which power units to operate, each negotiation unit activating or deactivating its respective power unit in accordance with said determining;
wherein the common method comprises:
determining a current total power demand of the microgrid;
determining a current total power available to the microgrid;
determining a current power excess, equal to the current total power available to the grid less the current total power demand of the grid;
grouping the power supply units in ascending order of priority identifier to obtain an ordered list of power supply priority;
deactivating where necessary, in order of the ordered list of power supply priority, as many of the power supply units as possible without exceeding the current power excess;
activating where necessary the remaining power supply units;
determining a current power ceiling, equal to the current total power available to the grid;
grouping the load units in descending order of priority identifier to obtain an ordered list of load priority;
activating where necessary, in order of the ordered list of load priority, as many of the load units as possible without exceeding the current power ceiling; and
deactivating where necessary the remaining load units.

2. The microgrid control system of claim 1, wherein negotiation is carried out in phases, and each phase of negotiation occurs after a predefined time interval of approximately 1 s.

3. The microgrid control system of claim 1, wherein each negotiation unit using a common method to determine which power units to operate involves each negotiation unit duplicating the processing of each other negotiation unit.

4. The microgrid control system of claim 1, wherein determining the current total power demand of the microgrid comprises summing the current power demand for activated load units and rated power demand for deactivated load units.

5. The microgrid control system of claim 1, wherein determining the current total power available to the microgrid comprises summing the rated power output of all available power output units.

6. The microgrid control system of claim 1, wherein the common method further comprises, for each group of power supply units, arranging the power supply units within that respective group in ascending order of time for which the respective power supply unit has been active, to obtain the ordered list of power supply priority.

7. The microgrid control system of claim 1, wherein deactivating where necessary, in order of the ordered list of power supply priority, as many of the power supply units as possible without exceeding the current power excess comprises deactivating where necessary, in order of the ordered list of power supply priority, as many of the power supply units as possible without exceeding the current power excess, unless a specific power supply unit was activated within a hysteresis time period.

8. The microgrid control system of claim 1, wherein the common method further comprises, if the current power excess is less than zero, reducing the current power ceiling by a headroom amount.

9. The microgrid control system of claim 1, wherein the common method further comprises, for each group of load units, arranging the load units within that respective group in descending order of time for which the respective load unit has been active, to obtain the ordered list of load priority.

10. The microgrid control system of claim 1, wherein activating where necessary, in order of the ordered list of load priority, as many of the load units as possible without exceeding the current power ceiling comprises activating where necessary, in order of the ordered list of load priority, as many of the load units as possible without exceeding the current power ceiling, unless a specific load unit was deactivated within a load hysteresis time period.

11. The microgrid control system according to claim 1, further comprising a microgrid comprising:
a plurality of power units connected together, the plurality of power units comprising:
at least one power supply unit; and
at least one load unit.

12. The microgrid control system according to claim 11, wherein the microgrid is an island microgrid and/or an islandable microgrid.

13. A method of operating the microgrid control system of claim 1, the method comprising:
determining a current total power demand of the microgrid;
determining a current total power available to the microgrid;
determining a current power excess, equal to the current total power available to the grid less the current total power demand of the grid;
grouping the power supply units in ascending order of priority identifier to obtain an ordered list of power supply priority;
deactivating where necessary, in order of the ordered list of power supply priority, as many of the power supply units as possible without exceeding the current power excess;
activating where necessary the remaining power supply units;
determining a current power ceiling, equal to the current total power available to the grid;
grouping the load units in descending order of priority identifier to obtain an ordered list of load priority;
activating where necessary, in order of the ordered list of load priority, as many of the load units as possible without exceeding the current power ceiling; and
deactivating where necessary the remaining load units.

14. A non-transitory computer-readable medium storing instructions for carrying out the method of claim 13.
